(19) United States
(12) Patent Application Publication
(10) Pub. No.: US 2024/0153171 A1
(43) Pub. Date: May 9, 2024

(54) BINDING DATA TO GRAPHIC OBJECTS USING A VISUAL INDICATOR

(71) Applicant: Adobe Inc., San Jose, CA (US)

(72) Inventors: Bernard KERR, Sausalito, CA (US); Dmytro BARANOVSKIY, Sydney (AU); Benjamin FARRELL, Hayward, CA (US)

(73) Assignee: Adobe Inc., San Jose, CA (US)

(21) Appl. No.: 17/980,480

(22) Filed: Nov. 3, 2022

(51) Int. Cl. G06T 11/20; G06T 11/60

(52) U.S. Cl. CPC G06T 11/206; G06T 11/60; G06T 2200/24

(57) ABSTRACT

Embodiments are disclosed for generating a data visualization. In some embodiments, a method of generating a data visualization includes generating a first graphic object on a digital canvas. A data set including data associated with a plurality of variables is added to a data panel of the digital canvas. A selection of a variable from the plurality of variables on the data panel is received and a second graphic object connecting the variable and a cursor position on the digital canvas is generated. A selection of a visual property of the first graphic object is received using the cursor. Upon selection of the visual property, the first graphic object is linked to the data panel via the second graphic object. A chart is then generated comprising the first graphic object and one or more new graphic objects, based on the variable and the visual property of the first graphic object.

### BACKGROUND

Data visualizations, such as charts, graphs, and other visualizations, provide a schematic representation of data that communicates information about the underlying data visually. Creating a data visualization may be a complex and iterative process as it often involves alternating between data manipulation and visual design aspects of the visualization being crafted. Traditional methods of creating data visualizations include using a visualization template, manually drawing the visualization, or writing computer code to build a unique data visualization.

### SUMMARY

Introduced here are techniques/technologies that enable a data visualization to be created by binding data to a visual property of a graphic object on a digital canvas. This data binding is performed on the digital canvas. Data is treated as another design element, like color, shapes, etc. This means that a designer can add datasets to the digital canvas and use them as part of their drawing by binding a variable from the dataset to a visual property of a graphic object. For example, the designer may add a spreadsheet to the digital canvas and then bind a variable from the spreadsheet to a shape they draw on the canvas. This binding establishes a relationship between the data in the dataset and the visual property of the graphic object. Additionally, multiple graphic objects can be created automatically corresponding, e.g., to each row of the variable. This automatically creates a data visualization of the data.

Additionally, this binding may be performed visually. For example, the dataset may be presented in a variables panel on the digital canvas. The designer can interact with the variables panel and drag-and-drop their desired dataset to their desired visual property to create the binding. In the process, a visual indicator (e.g., a line, curve, etc.) is displayed linking the selected variable to the cursor and ultimately to the selected visual property. Once bound, the indicator goes away, leaving a data visualization that is bound to the selected dataset. Further, the underlying dataset can be swapped for a new dataset or a different variable from the same dataset. Using the bindings, and the new dataset, the data visualization is then automatically updated.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of binding data to graphic objects using a visual indicator in accordance with one or more embodiments;

FIG. 2 illustrates a diagram of a user interface that enables generating a data visualization from data bound objects in accordance with one or more embodiments;

FIGS. 3 and 4 illustrate an example of binding data to a property of a graphic object in accordance with one or more embodiments;

FIGS. 5 and 6 illustrate an example of binding data to a graphic object on a digital canvas in accordance with one or more embodiments;

FIGS. 7-9 illustrate an example of swapping the underlying data bound to a data visualization in accordance with one or more embodiments;

FIG. 10 illustrates a schematic diagram of a data visualization system in accordance with one or more embodiments;

FIG. 11 illustrates a flowchart of a series of acts in a method of generating a data visualization in accordance with one or more embodiments; and

FIG. 12 illustrates a block diagram of an exemplary computing device in accordance with one or more embodiments.

### DETAILED DESCRIPTION

One or more embodiments of the present disclosure are directed to the creation of graphic objects that are bound to data. Data visualizations (e.g., charts, infographics, etc.) are a tool for communicating information about a data set to viewers. Through data visualizations, information can be clearly and creatively presented. Previously, data visualization techniques were manually implemented. For example, charts and graphs that include various graphic objects were manually drawn to match a dataset. Although this provides maximum creativity, as the data visualization is drawn from scratch by the designer, it is slow and not readily applicable to new charts or datasets. For example, if changes to the underlying dataset were made, or if a new visualization were desired, the previous data visualizations had to be thrown out and new ones created. Alternatively, custom code was written to generate data visualizations from a dataset. Although such code could potentially create new data visualizations from different datasets, it requires significant technical ability, both in programming expertise and data science expertise, to create the code.

Embodiments provide simple and intuitive techniques for generating data visualizations. For example, a designer can sketch one or more graphic objects on a digital canvas, such as drawing shapes, adding text, etc. The visual properties of the new graphic object (e.g., dimensions, position, scale, color, text, etc.) are then available to be bound to data. In some embodiments, such binding (e.g., associating a visual property of a graphic object with data) can be performed graphically, on the digital canvas. For example, once both a graphic object and a dataset have been added to the digital canvas, the designer can drag a variable from the dataset to a target on the graphic object. When the designer selects the variable (e.g., at the beginning of the drag operation), the available properties of graphic objects on the digital canvas that can be bound to that variable are highlighted with “targets”. The available targets may vary depending on the type of data selected (e.g., numerical, categorical, etc.) and the graphic objects on the canvas.

As the designer drags the data to the target, a visual indicator is shown in the user interface. The visual indicator may take the form of a line, curve, shape, or other graphic object connecting the selected variable to the cursor. Once the cursor reaches the desired target, the target and the variable are linked via the visual indicator and that target is then bound to the variable's data. Once bound, the visual property represented by the target is modified based on the data and the visual indicator is removed from the user interface. This has the effect of binding data just as if it had been entered and linked manually, but via a more intuitive, and visual, interface.

In addition to binding data to a graphic object on the canvas, embodiments also enable data to be bound to the visual properties of a selected graphic object between panels of the user interface. For example, the dataset may be represented in a variables panel which presents details regarding the variables of a dataset that has been added to a drawing. Similarly, when a graphic object on the canvas is selected, its properties may be represented in a properties panel. The designer can then select and drag a variable from the variables panel to a target on the properties panel. As in the on-canvas example, eligible visual properties of the graphic object may be highlighted in the properties panel as targets. The visual indicator is similarly displayed connecting the variable to the cursor, until a target is selected, and the data is bound to the visual property.

Additionally, once a data visualization has been created, the underlying dataset can be swapped out. This allows for a new data visualization to be created without requiring the designer to start from scratch. For example, once one data visualization has been created, it can be duplicated. This retains all of the preexisting visual properties of the data visualization as well as the data bindings. The designer can then select a new dataset to replace the existing dataset. The data visualization can be updated automatically or based on user input, depending on mappings between the variable names.

Embodiments allow for designers to sketch first and then bind their sketch to data. It also enables designers to bind data directly with the graphic objects on the canvas, without having to rely on other specialized panels or defining the binding via coding. Additionally, embodiments enable designers to swap the underlying data to which their designs are bound. This makes it simple for designers to update existing designs quickly or incorporate new data into their designs.

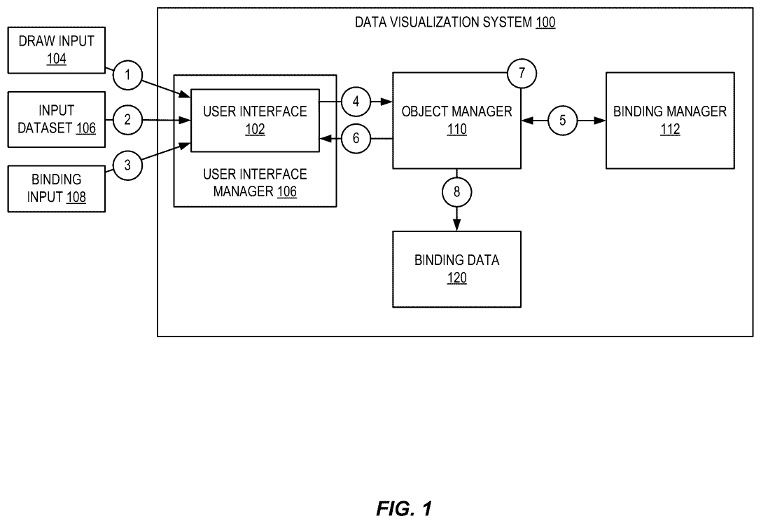

FIG. 1 illustrates a diagram of a process of binding data to graphic objects using a visual indicator in accordance with one or more embodiments. As shown in FIG. 1, a data visualization system 100 may enable designers, or other users, to generate data visualizations from underlying source data. Data visualization system 100 may be implemented as part of a graphic design application, such as a vector graphic design application, which enables designers to create various graphic objects (e.g., shapes, lines, text boxes, etc.). In some embodiments, the data visualization system 100 executes on a computing device, such as a PC, laptop, server or any other device including one or more processors capable of executing computer-readable instructions stored on a storage medium.

The data visualization system 100 includes a user interface 102 through which a designer can interact with the data visualization system to create a drawing including graphic objects and bind those graphic objects to data. The user interface may include a digital canvas on which the designer may create various designs (e.g., draw lines and shapes, add text, images, etc.). For example, at numeral 1, the designer can provide a drawing input 104 to create a graphical object. This may include drawing an arbitrary shape in the user interface 102, selecting an existing shape on the digital canvas, etc. For example, if the designer is drawing a bar chart, then the designer may use a shape tool to draw a rectangle (e.g., to represent one of the bars of the bar chart).

As shown at numeral 2, the designer may provide input data 106 to the data visualization system. The data may be input directly into the data visualization system (e.g., entered manually, copy pasted, etc.) or provided from another source, such as a file including the dataset (e.g., a spreadsheet, database, etc.). Such a file may be imported from a local storage location (e.g., on the same computing device on which the data visualization system is executing) or a remote storage location accessible via a network. The data visualization system can identify one or more variables associated with the data and present the variables to the user (e.g., via a variable or data user interface element, such as a window, overlay, etc.).

In some embodiments, when the input dataset 106 is received, one or more variables are identified from the data set. These variables may be displayed within the GUI 102 (e.g., in a variables panel, list, or other GUI element). In some embodiments, the variables are identified based on a known data format. For example, labels of columns or rows may be extracted from the dataset based on the data format associated with the dataset. The designer can then bind a variable of the dataset to a visual characteristic of one or more graphic objects.

In the example of FIG. 1, at numeral 3, the designer provides a binding input 108 via user interface 102. This may include one or more input selections of graphic objects to be bound to a variable of the input dataset 106. In some embodiments, the binding input 108 includes selecting a variable from a variables panel of the user interface 102 and dragging the cursor to a target on a graphic object. For example, the designer may click, tap, etc. on the selected variable and then drag to a target on a graphic object. Although embodiments are generally discussed with respect to the use of inputs via mouse, trackpad, finger, etc., embodiments may also be used with different input techniques, such as gaze detection, voice commands etc.

In some embodiments, when a variable is selected, the targets available for binding to that variable type may be identified. For example, at numeral 4, once the variable has been selected, it is passed to object manager 110. Object manager 110 is responsible for managing the appearance of graphic objects, maintaining data bindings between variables and graphic objects, as well as creating additional graphic objects based on the bindings. The object manager 110 can identify a data type (e.g., text, numerical, etc.) associated with the selected variable and provide that to binding manager 112 at numeral 5.

Binding manager 112 can determine which visual characteristics of graphic objects can be bound to the selected variable type. For example, the available visual characteristics which the designer may select may include some or all visual characteristics relating to the type of object selected. For instance, the visual characteristics for a geometric shape object (e.g., a “shape”) may include width, height, position, orientation, fill, border, opacity. In some embodiments, the area of an object may also be a bindable visual characteristic. Visual properties for an image may include one or more of the previous properties in addition to contrast and brightness properties, and a text box object may include additional properties, including font and spacing. Additionally, the visual characteristics available for selection can be further based on the type of variable selected. For instance, a number variable type may include visual properties that with numerical property values, such as width, height, position, and orientation. Color of a fill or border may also be presented for number type variables. For text type variables, the color of a fill or border may be presented as visual property types.

Based on the variable type and the graphic objects, the available visual characteristics are determined by binding manager 112. This may be performed for every graphic object on the digital canvas. In some embodiment, this may be determined for only some of the graphic objects on the digital canvas. For example, the designer may select one or more graphic objects and only those in the selection are evaluated. Once the available visual characteristics are determined, they are returned to the object manager 110 which causes, at numeral 6, the graphic objects to be highlighted with “targets” corresponding to the available visual characteristics in the user interface. For example, if the designer selects a numerical variable such as temperature, then a number of targets may be highlighted on a shape on the digital canvas. The designer can then drag the variable to one of the targets. As the designer drags the variable, a visual indicator is displayed. The visual indicator may take the form of a line, shape, or other graphic indicator that highlights the path of the cursor between the variable on the variable panel and the targets on the canvas (or on a properties panel).

At numeral 7, a data binding is created between the selected graphic object and selected variable by object manager 110. The data binding creates a relationship between the data and the selected the visual characteristic of the selected graphic object. In some embodiments, the binding creates and binds one object to each row of data from the corresponding variable of the dataset. For example, when data is bound to a rectangle on the digital canvas, it may be bound to a first row of the data and multiple new rectangles are created and bound for the remaining rows of the data. The data binding may be one to one (e.g., data variable=10 is used to set position x=10 or data variable=#FFFFFF is used to set fill color=#FFFFFF). Alternatively, the relationship has an additional layer of complexity, such as color binding scale, e.g., data variable=50 is used to set the fill color to a grey color between 0=white and 100=black. Similarly, the relationship may define a formula between the data variable value and the property (e.g., data variable=1 is sued to set font format=BOLD while data variable=2 is used to set font format=Italic).

In some embodiments, the data binding is maintained and stored by the object manager 110. In accordance with the association between the variable and the visual property, an observation within the data (such as a row in a spreadsheet) will correspond to a graphic object to which the visual property applies. As discussed, each data observation is mapped to a grouping of graphic objects, which may be referred to as a cell, and at least one graphic object within that cell has a visual property associated with the data variable.

In some embodiments, the object manager 110 also creates additional graphic objects based on the initial graphic object such that each observation in the dataset has a corresponding graphic object. For example, additional graphic objects are created by automatically duplicating or repeating the initial graphic object such that the object type is the same as the initial graphic object. The additional graphic objects may be automatically created and displayed when the designer binds a data variable to a visual property of the initial graphic object. Alternatively, after the binding the designer may instruct the data visualization system to create the additional graphic objects (e.g., by selecting a GUI element). This leads to a data visualization being automatically generated upon binding the initial graphic object to a variable of a dataset. This data visualization includes a plurality of graphic objects that were generated based on the initial graphic object and bound to the same variable of the dataset 106.

In some embodiments, as each object within the plurality of graphic objects is created, the visual property for the object is rendered in accordance with the binding. Specifically, the value for the visual property of a graphic object is based on a variable value for the corresponding observation. The new graphic objects may be created such that they are aligned with the initial graphic object in both position and scale. For example, a new coordinate system may be established based on the position of the initial graphic object. This allows each new graphic object to share an origin with the initial graphic object, allowing for the initial object and new objects to all be aligned along one axis. Additionally, the visual characteristic of each new graphic object is set such that the value the new graphic object is representing is appropriate relative to the initial graphic object. For example, where the initial graphic object is a bar, the origin may be set to the left edge of the bar. Other origins may also be used, either selected automatically by the data visualization system, by the designer, etc. If the data is bound to the length of the bar, then each newly generated bar's length will be set such that each bar represents that length on the same scale as the initial bar. These new graphic objects may be aligned and rendered within the user interface 102. At numeral 8, the data bindings for each object may be stored in binding data 120.

There are a number of benefits to working with data bound objects rather than hard coded, or manually constructed visualizations. For example, if the underlying dataset is changed or updated, the corresponding bound visualization is likewise updated. In such an instance, the corresponding data binding is updated by object manager 110 and the updated data binding is stored to binding data 120, replacing any previous bindings. Any changes to the visual characteristics as a result of the new underlying dataset are automatically rendered accordingly. This saves significant effort that would otherwise be required to update manually constructed charts. Additionally, no specialized coding knowledge is required to create the visualization. Instead, sophisticated data visualizations can be constructed by anyone capable of using a graphic design tool and access to the data to be visualized.

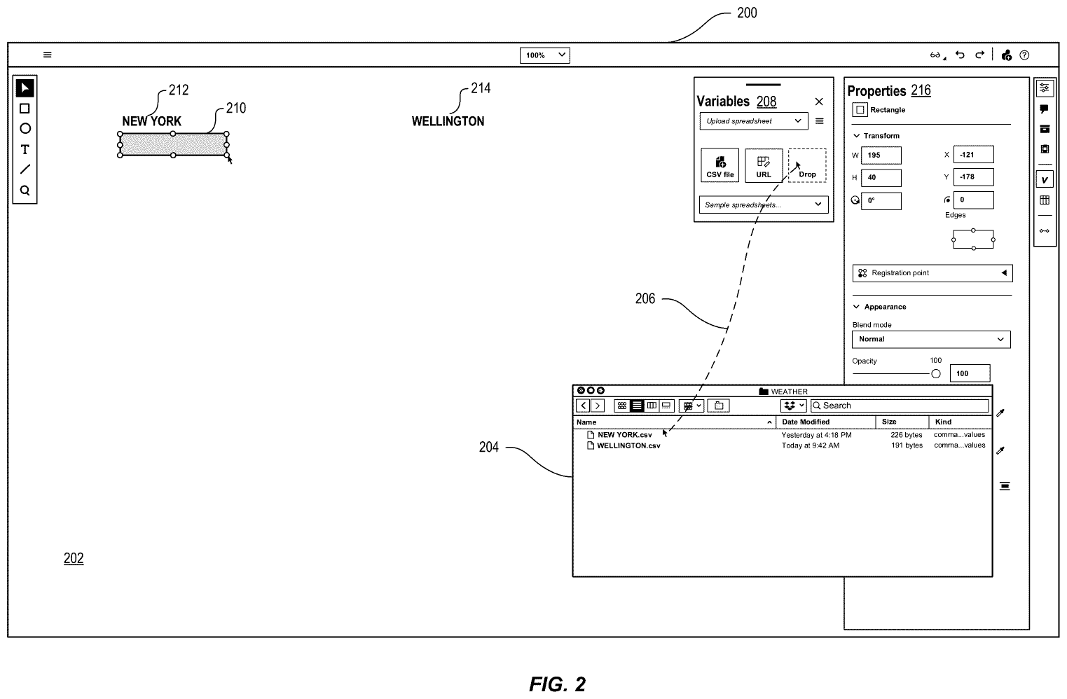

FIG. 2 illustrates a diagram of a user interface 200 that enables generating a data visualization from data bound objects in accordance with one or more embodiments. As shown in FIG. 2, the user interface 200 can include a digital canvas 202 which provides an area in which the designer can draw graphic objects, create data visualizations, etc. As discussed, the designer can provide a dataset to be bound to graphic objects. In the example of FIG. 2, the designer has local datasets NEW YORK.csv and WELLINGTON.csv, as shown at 204. In this instance, the designer provides the NEW YORK.csv dataset by dragging and dropping 206 the dataset into variables panel 208. Additionally, in the example of FIG. 2, the designer has drawn a rectangle geometric shape 210 and a text box 212 including the text NEW YORK and a text box 214 including the text WELLINGTON. The rectangle 210 has been selected, which results in properties panel 216 showing various properties of the rectangle (e.g., width, height, position, etc.).

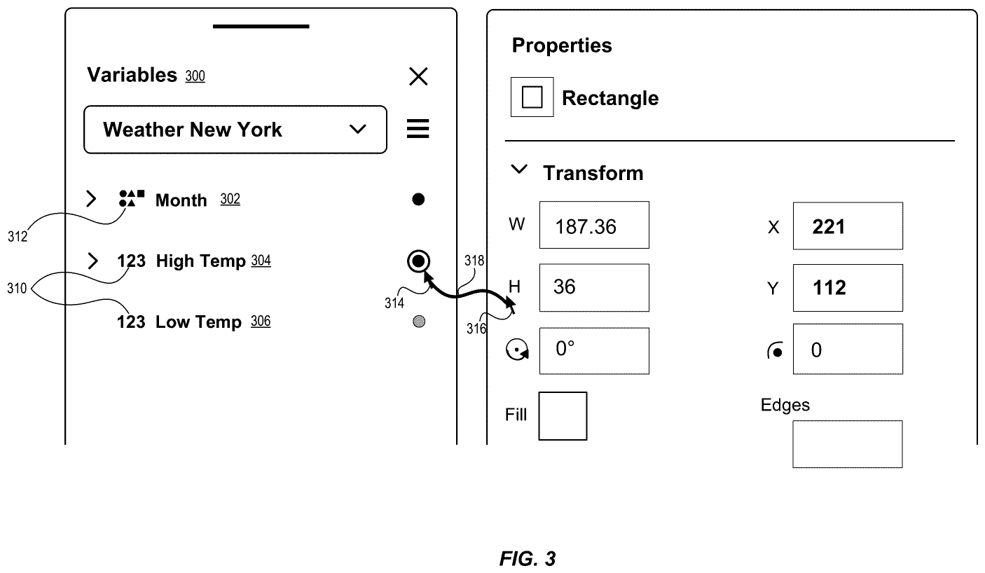

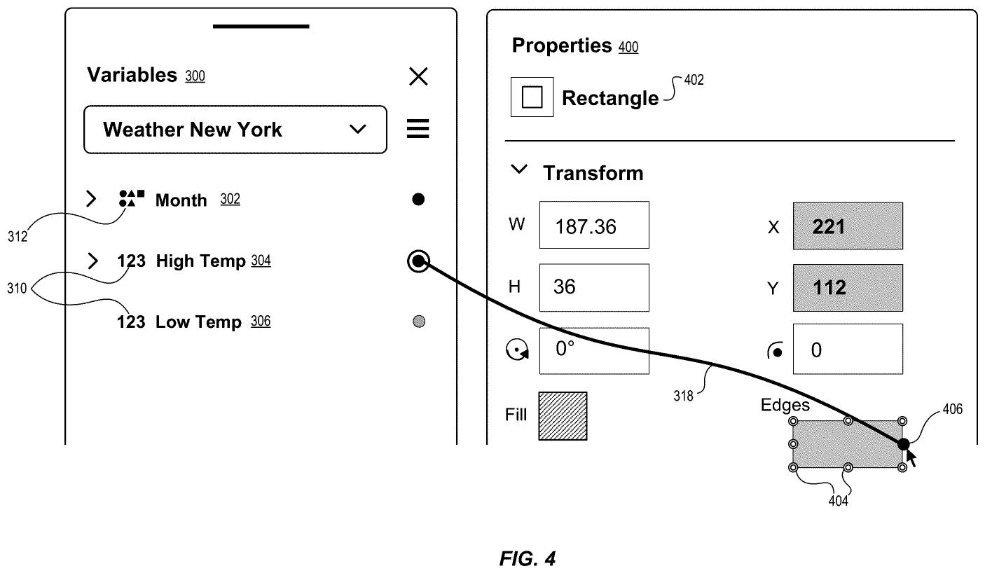

FIGS. 3 and 4 illustrate an example of binding data to a property of a graphic object in accordance with one or more embodiments. Continuing the example from FIG. 2, once the dataset has been provided, the data visualization system identifies variables associated with the dataset. This is reflected in variables panel 300, which now shows three variables associated with the dataset: month 302, high temp 304, and low temp 306. Additionally, the variables panel further identifies a type associated with each variable. For example, high temp 304 and low temp 306 are indicated as being numerical types 310 while month 302 is indicated as being categorical type 312.

As discussed, the designer can bind variables from the dataset to visual characteristics of a graphic object. The designer can select a variable (e.g., tap, click, etc.) to be bound to a property of a graphic object. In this example, the designer selects the high temp 304 variable as shown at 314. Thereafter, as the designer moves the cursor to a new position (e.g., via tap and drag, click and drag, or other gesture or movement), a visual indicator 318 is displayed. The visual indicator 318 extends from the selected variable to the current position of the cursor. This makes it clear which variable is currently being bound. In some embodiments, when the variable is selected, in addition to the visual indicator, the properties panel is updated with targets associated with properties to which the selected variable can be bound.

For example, as shown in FIG. 4, In this example, a rectangle (e.g., shape 210) was selected on the digital canvas. As a result, properties panel 400 shows the properties of rectangle 402. In particular, several properties in the properties panel have been greyed-out, as compared to their counterparts in FIG. 3. This indicates that they are available for binding (e.g., position, fill, and edges) to the high temp dataset 304. Additionally, targets 404 have been added to edges of the rectangle which further indicate potential properties that may be bound to the dataset. In this instance, the high temperature variable 304 is being bound to the right edge 406 of the selected graphic object (in this case rectangle 402). Further, as shown in FIG. 4, the visual indicator 318 has continued to follow the cursor position and now visually links the high temp variable 304 and the right edge property 406 of the graphic object. As discussed, the visual indicator may follow the path of the cursor on the digital canvas or may be a line or curve (e.g., a path object) linking the selected variable to the current position of the cursor.

Upon release (e.g., releasing the click, removing the finger or stylus from the screen, etc.) the selected variable is bound to the selected property. Depending on the number of rows associated with the high temp variable 304 additional graphic objects being generated and bound to a different row. Each new graphic object is automatically sized based on the data binding. In this example, the right edge of each graphic object is positioned based on the linked value from the high temp variable 304. Data bindings for each object are generated and stored.

Although FIG. 4 shows binding being performed between the variables panel 300 and the properties panel 400, in various embodiments such binding may be performed from the variables panel to the graphic object directly on the digital canvas, e.g., by selecting the high temp variable (or other variable of interest) and linking it to the right edge of the graphic object.

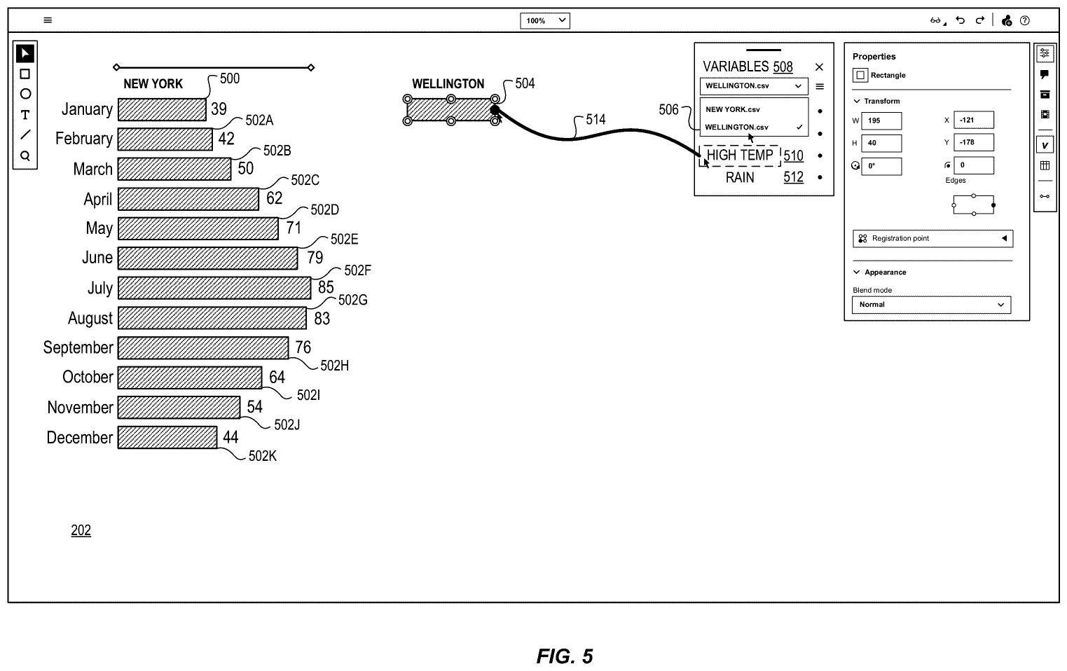

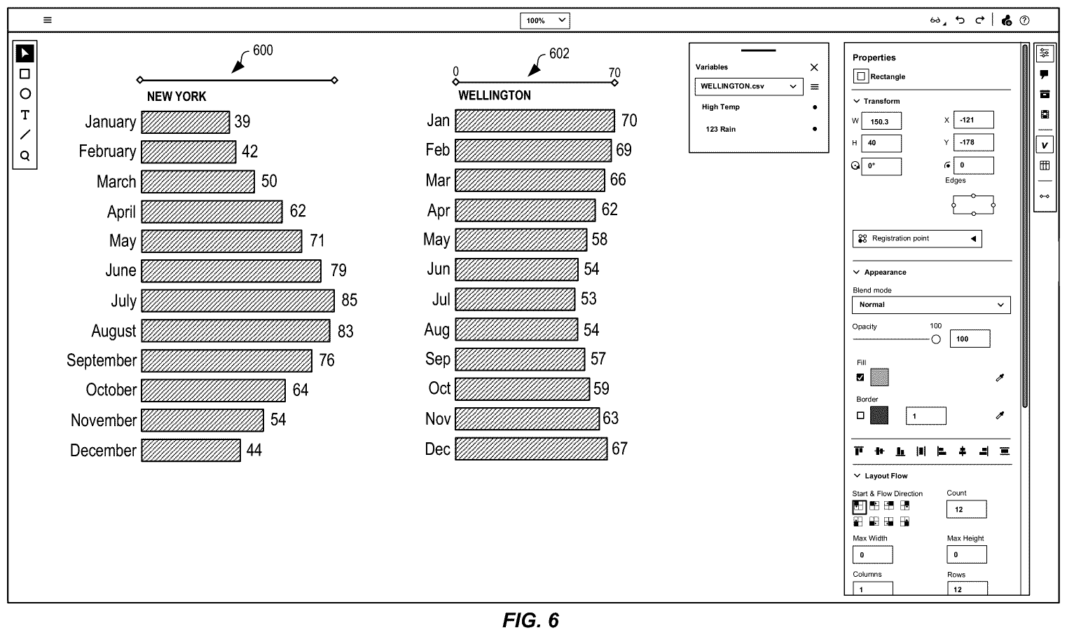

FIGS. 5 and 6 illustrate an example of binding data to a graphic object on a digital canvas in accordance with one or more embodiments. As shown in FIG. 5, following the binding operation illustrated in FIGS. 3 and 4, additional graphic objects 502A-502K have been created and populated alongside original graphic object 500. As discussed with respect to FIG. 4, the right edge of each bar is bound to a variable from the dataset. In this instance, the variable is the high temp variable from the NEW YORK.csv dataset. The data visualization created multiple new bars and bound them to variable values based on the dataset. For example, because the dataset includes average monthly high temperatures for New York City, the high temperature variable is identified having twelve observations (e.g., one for each month). As such, eleven new bars are created and bound to the dataset, with the right edge of each bar corresponding to the average temperature value for a corresponding month. The resulting chart may also be annotated with various labels. For example, the name of each month may be added to the chart, placed in such a way that the label is associated with its corresponding bar.

In addition to the New York data visualization, in the example of FIG. 5 a data visualization is being constructed for Wellington. As shown in FIG. 5, the designer has created a new graphic object 504 to serve as the initial graphic object of the Wellington data visualization. In some embodiments, this initial graphic object 504 may be generated by duplicating the initial graphic object 500 from the New York data visualization to serve as the initial graphic object 504 for the Wellington data visualization. In some embodiments, duplicating a graphic object from a data visualization also duplicates its existing data bindings. In such instance, attempting to bind the same visual property to a new dataset may be treated as a request to swap datasets. The process of swapping datasets is discussed in further detail below.

As discussed, in addition to binding data to properties using the variables and properties panels, data can be bound directly to objects on digital canvas 202. In this example, the designer selects the Wellington dataset 506 in variables panel 508. This results in variables panel 508 showing two variables associated with the Wellington dataset: high temp 510 and rain 512. The designer then selects high temp 510 and moves the cursor onto the digital canvas. As in the example of FIGS. 3 and 4, a visual indicator 514 connects the cursor to the selected variable from the variables panel 508. Additionally, the initial graphic object 504 is highlighted with targets to which the variable can be bound. Although in this example only the initial graphic object 504 is highlighted with targets, in some embodiments all or some of the other graphic objects (e.g., 500 and 502A-K) may be similarly highlighted.

Once the target is selected, the data is bound to the visual characteristic of the graphic object associated with the target. In this example, the Wellington high temp variable 510 is bound to the right edge of the initial graphic object 504. Upon release, additional graphic objects are generated for each row of the high temp dataset 510, as shown in FIG. 6. As shown, this results in two data visualizations, one for New York's high temperatures 600 and one for Wellington's high temperatures 602. These are bound to the underlying datasets without any coding or manual construction. Instead, because data is treated as another drawing element, the data visualizations can be created quickly and automatically based on the sketches of the designer. Additionally, because the data visualizations are bound, any changes to the underlying datasets are reflected in updated data bindings, which result in automatic updates being made to the bound data visualizations.

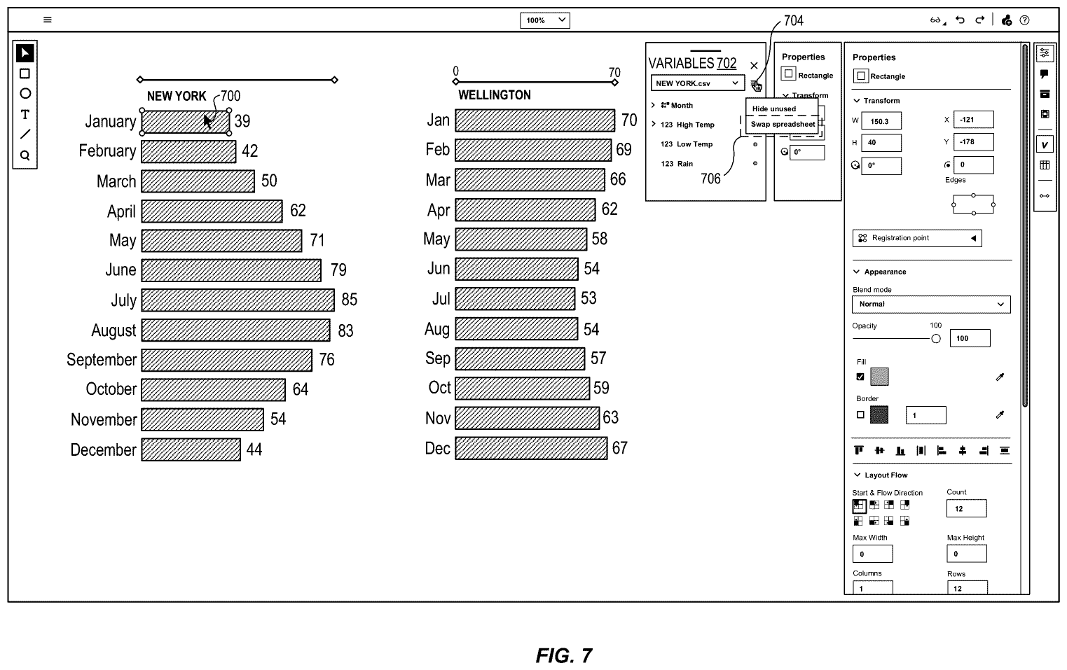

FIGS. 7-9 illustrate an example of swapping the underlying data bound to a data visualization in accordance with one or more embodiments. As shown in FIG. 7, the designer can select a graphic object 700 from one of the data visualizations. In this instance, the designer selects a graphic object from the New York high temp data visualization. This results in details of the data binding being displaying in variables panel 702. The variables panel 702 then gives the designer the option of swapping the underlying dataset. For example, the designer can select a menu icon 704 adjacent to the dataset name and select the swap spreadsheet option 706.

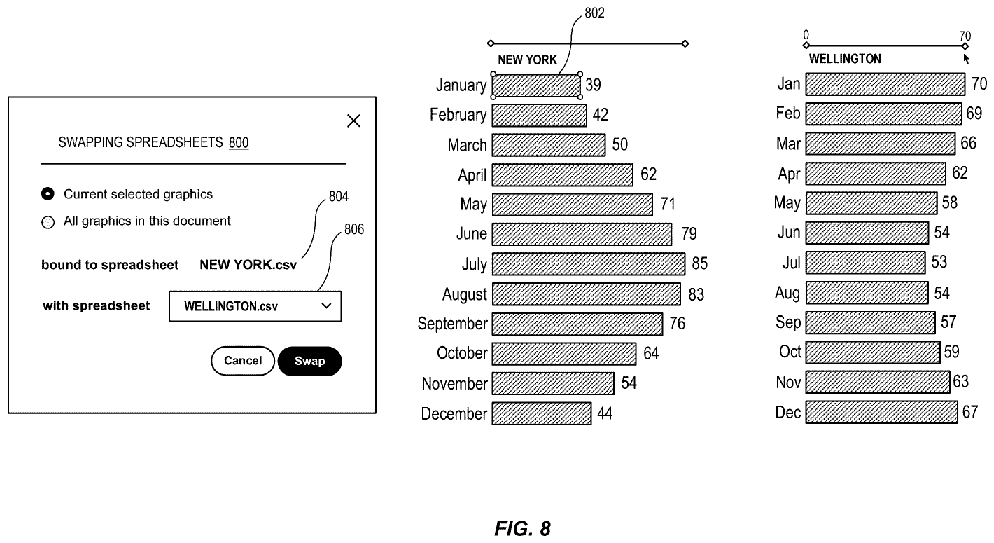

Upon selection of the swap spreadsheet option 706, the designer is presented with a swapping spreadsheets panel 800, as shown in FIG. 8. As shown, the swapping spreadsheets panel presents the option of swapping spreadsheets for all graphics in the document or only selected graphics. In some embodiments, the current selected graphics option may select all graphic objects belonging to the same data visualization as a selected graphic object. For example, bar 802 is selected and therefore all graphic objects associated with the New York data visualization are treated as selected. Alternatively, each graphic object associated with the data visualization may be separately selected. Based on the selection, the current binding is indicated 804 and the designer can select a dataset from available datasets 806 to swap.

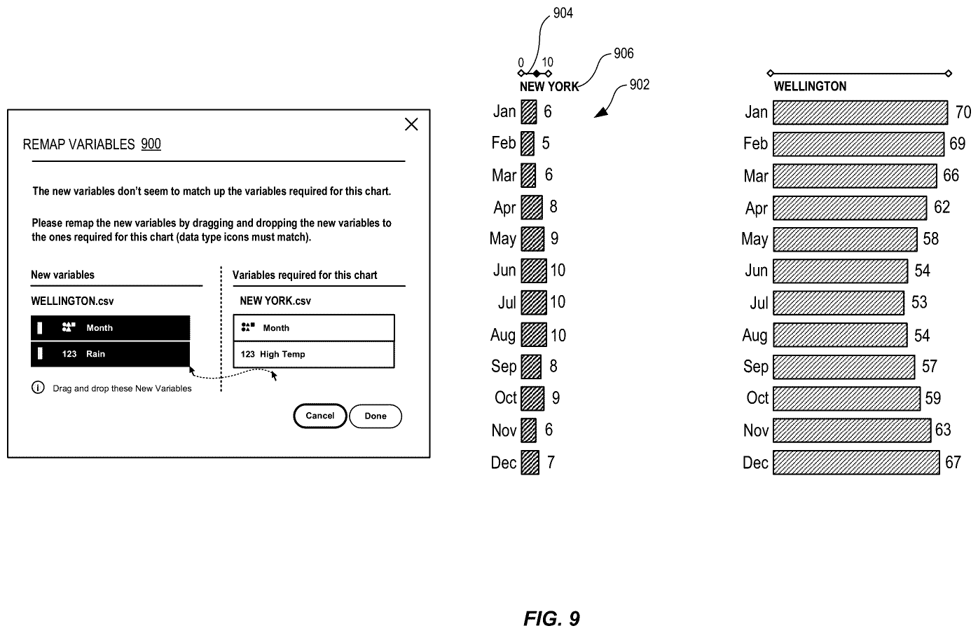

When swapping datasets, if the variable names match, then the swap may be performed automatically. For example, if the New York high temp and Wellington high temp are both named the same, then the data bindings may be automatically updated from New York to Wellington and the data visualization is updated accordingly. However, if a different variable is being used, or if the naming conventions are different, then manual input may be required. For example, the Wellington dataset also includes monthly rain totals. As shown in FIG. 9, if the designer wants to swap the New York high temp variable for the Wellington rain variable, then additional input is needed.

In the example of FIG. 9, a remap variables panel 900 is presented. This allows the designer to drag the variables to be remapped from the New York dataset to the Wellington dataset. In this instance, the binding associated with high temp variable of the New York dataset is being remapped to the rain variable of the Wellington dataset. The rest of the binding remains the same. For example, the right edge of the graphic objects is bound to the high temp variable of the New York dataset. Upon remapping, the right edge of the graphic objects remains bound, but the underlying dataset to which they are bound has been replaced by the rain variable of the Wellington dataset. This results in the data visualization being automatically updated as shown at 902. In this instance, the scale of the previous mapping is also retained. This results in much shorter bars, as the rainfall values are, numerically, much smaller than the temperature values. This can be modified by the designer using the scale controls 904 presented on the digital canvas (e.g., allowing the bars to be proportionally lengthened to better represent the new data values). Additionally, the text box New York 906 has not been updated. In some embodiments, the text box may be bound to the name of the dataset and may be updated automatically as well when the dataset is swapped. Alternatively, the title can be updated manually.

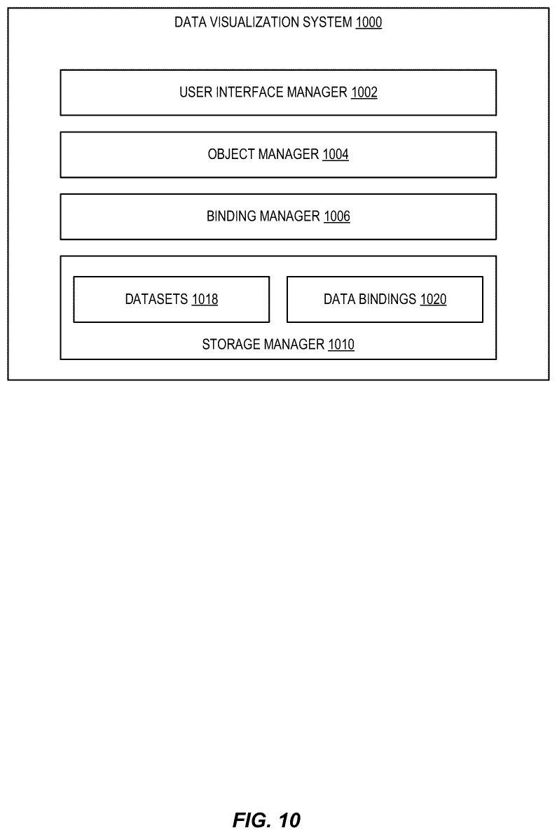

FIG. 10 illustrates a schematic diagram of data visualization system 1000 (e.g., “data visualization system” described above) in accordance with one or more embodiments. As shown, the data visualization system 1000 may include, but is not limited to, user interface manager 1002, object manager 1004, binding manager 1006, and storage manager 1010. The storage manager 1010 includes datasets 1018 and data bindings 1020.

As illustrated in FIG. 10, the data visualization system 1000 includes a user interface manager 1002. For example, the user interface manager 1002 allows users to create graphic objects and bind them to data to create data visualizations. In some embodiments, the user interface manager 1002 provides a user interface through which the user can interact with the data visualization system and individual data visualizations, as discussed above. Alternatively, or additionally, the user interface may enable the user to download data visualizations from a local or remote storage location (e.g., by providing an address (e.g., a URL or other endpoint) associated with a storage location).

Additionally, the user interface manager 1002 allows users to bind data to graphic objects visually. For example, the user interface manager can render a user interface that includes a properties panel and a variables panel. The designer can select a variable from the properties panel and drag their cursor (e.g., using a mouse, finger, stylus, or other pointing device) from a variable to a graphic object on a digital canvas. The user interface manager can render targets and/or highlight properties to which the variable can be bound. Similarly, the designer can select a variable from the properties panel and bind the variable to a property on the properties panel, where the properties panel displays properties of a selected graphic object. In both instances, a visual indicator (e.g., line, curve, or other graphic object) links the selected variable to the cursor. This makes it clear which variable is being bound to which property, as the designer sketches.

As illustrated in FIG. 10, the data visualization system 1000 includes an object manager 1004. The object manager 1004 is responsible for binding graphic objects to a dataset. In particular, the object manager can be used to construct a data visualization from scratch, as discussed above. For example, the object manager 1004 binds a visual characteristic of a graphic object to a variable from a dataset 1018. In some embodiments, there may be a visual indicator of the binding. In some embodiments, the data bindings 1020 are maintained and stored by the object manager or storage manager 110. The binding represents a relationship between the visual characteristic and the data values of the variable. This can be a one-to-one relationship, a linear relationship, a non-linear relationship, a relationship defined by a specific formula, etc.

As a result of the data binding, any change to the data in the dataset to which it is bound results in a change to the visual characteristic of the graphic object. Likewise, if the underlying dataset associated with the binding is swapped for another dataset, then the bindings are updated to be associated with the new dataset. The bound visual characteristic is then automatically updated to reflect the new dataset. Further, when the data is bound to a graphic object, if the variable is associated with multiple observations, then multiple graphic objects may be created and bound, each having the same visual characteristic bound to the dataset.

As illustrated in FIG. 10, the data visualization system 1000 includes binding manager 1006. As discussed, binding manager 1006 is responsible for determining the properties that are available to be bound to a particular variable type. For example, the available visual characteristics which the designer may select may include some or all visual characteristics relating to the type of object selected. For instance, the visual characteristics for a geometric shape object (e.g., a “shape”) may include width, height, position, orientation, fill, border, opacity. In some embodiments, the area of an object may also be a bindable visual characteristic. Visual properties for an image may include one or more of the previous properties in addition to contrast and brightness properties, and a text box object may include additional properties, including font and spacing. Additionally, the visual characteristics available for selection can be further based on the type of variable selected. For instance, a number variable type may include visual properties that with numerical property values, such as width, height, position, and orientation. Color of a fill or border may also be presented for number type variables. For text type variables, the color of a fill or border may be presented as visual property types. Once the available properties have been identified, they can be provided to the object manager 1004, as discussed, and used to highlight specific properties of graphic objects on the digital canvas to aid the designer in selecting properties to be bound.

As illustrated in FIG. 10, the data visualization system 1000 also includes the storage manager 1010. The storage manager 1010 maintains data for the data visualization system 1000. The storage manager 1010 can maintain data of any type, size, or kind as necessary to perform the functions of the data visualization system 1000. The storage manager 1010, as shown in FIG. 10, includes the datasets 1018. As discussed, datasets 1018 can be input directly into the data visualization system (e.g., entered manually, copy pasted, etc.) or provided from another source, such as a file including the dataset (e.g., a spreadsheet, database, etc.). Such a file may be imported from a local storage location (e.g., on the same computing device on which the data visualization system is executing) or a remote storage location accessible via a network. The data visualization system can identify one or more variables associated with the data and present the variables to the user (e.g., via a variable or data user interface element, such as a window, overlay, panel, etc.).

As further illustrated in FIG. 10, the storage manager 1010 also includes data bindings 1020. As discussed, the data bindings represent a relationship between a visual characteristic and data. The data binding creates a relationship between the data and the selected the visual characteristic of the selected graphic object. In some embodiments, the binding creates and binds one object to each row of data from the corresponding variable of the dataset. The data binding may be one to one (e.g., data variable=10 is used to set position x=10 or data variable=#FFFFFF is used to set fill color=#FFFFFF). Alternatively, the relationship has an additional layer of complexity, such as color binding scale, e.g., data variable=50 is used to set the fill color to a grey color between 0=white and 100=black. Similarly, the relationship may define a formula between the data variable value and the property (e.g., data variable=1 is sued to set font format=BOLD while data variable=2 is used to set font format=Italic). If the underlying data is swapped, then the binding(s) 1020 are updated using the new dataset.

Each of the components 1002-1010 of the data visualization system 1000 and their corresponding elements (as shown in FIG. 10) may be in communication with one another using any suitable communication technologies. It will be recognized that although components 1002-1010 and their corresponding elements are shown to be separate in FIG. 10, any of components 1002-1010 and their corresponding elements may be combined into fewer components, such as into a single facility or module, divided into more components, or configured into different components as may serve a particular embodiment.

The components 1002-1010 and their corresponding elements can comprise software, hardware, or both. For example, the components 1002-1010 and their corresponding elements can comprise one or more instructions stored on a computer-readable storage medium and executable by processors of one or more computing devices. When executed by the one or more processors, the computer-executable instructions of the data visualization system 1000 can cause a client device and/or a server device to perform the methods described herein. Alternatively, the components 1002-1010 and their corresponding elements can comprise hardware, such as a special purpose processing device to perform a certain function or group of functions. Additionally, the components 1002-1010 and their corresponding elements can comprise a combination of computer-executable instructions and hardware.

Furthermore, the components 1002-1010 of the data visualization system 1000 may, for example, be implemented as one or more stand-alone applications, as one or more modules of an application, as one or more plug-ins, as one or more library functions or functions that may be called by other applications, and/or as a cloud-computing model. Thus, the components 1002-1010 of the data visualization system 1000 may be implemented as a stand-alone application, such as a desktop or mobile application. Furthermore, the components 1002-1010 of the data visualization system 1000 may be implemented as one or more web-based applications hosted on a remote server. Alternatively, or additionally, the components of the data visualization system 1000 may be implemented in a suite of mobile device applications or “apps.”

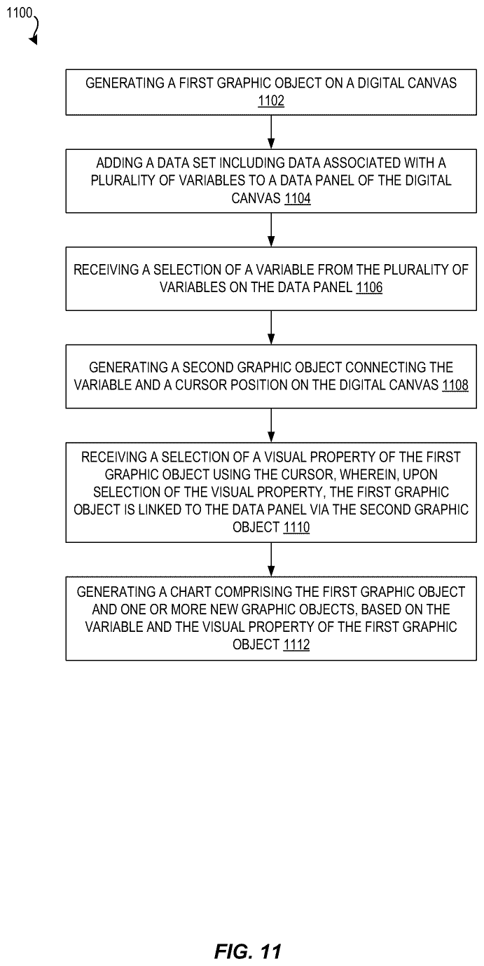

FIGS. 1-10, the corresponding text, and the examples, provide a number of different systems and devices that allows a user to change coordinate systems for data bound objects. In addition to the foregoing, embodiments can also be described in terms of flowcharts comprising acts and steps in a method for accomplishing a particular result. For example, FIG. 11 illustrates a flowchart of an exemplary method in accordance with one or more embodiments. The method described in relation to FIG. 11 may be performed with fewer or more steps/acts or the steps/acts may be performed in differing orders. Additionally, the steps/acts described herein may be repeated or performed in parallel with one another or in parallel with different instances of the same or similar steps/acts.

FIG. 11 illustrates a flowchart 1100 of a series of acts in a method of generating a data visualization in accordance with one or more embodiments. In one or more embodiments, the method 1100 is performed in a digital medium environment that includes the data visualization system 1000. The method 1100 is intended to be illustrative of one or more methods in accordance with the present disclosure and is not intended to limit potential embodiments. Alternative embodiments can include additional, fewer, or different steps than those articulated in FIG. 11.

As illustrated in FIG. 11, the method 1100 includes an act 1102 of generating a first graphic object on a digital canvas. As discussed, a data visualization may include a digital canvas. The digital canvas may include a variety of drawing tools that enable a designer to draw on the canvas. For example, the designer may sketch a shape on a digital canvas shape tool. The designer may similarly add lines, curves, or other path objects, add or change color fills, or otherwise add or modify visual properties of graphic objects on the digital canvas. Additionally, or alternatively, the designer may add text to a text box, import an image, etc.

As illustrated in FIG. 11, the method 1100 also includes an act 1104 of adding a data set including data associated with a plurality of variables to a data panel of the digital canvas. As discussed, the designer may add the dataset to the data visualization system directly (e.g., manual entry, copy-paste, etc.) or via a file that includes the dataset (e.g., a spreadsheet, database, etc.).

As illustrated in FIG. 11, the method 1100 also includes an act 1106 receiving a selection of a variable from the plurality of variables on the data panel. As discussed, when the designer adds a dataset, one or more variables of the dataset may be identified by the data visualization system. These variables may be presented to the designer in the user interface via a panel or other GUI element. The designer may use a pointing device (e.g., finger, stylus, mouse, trackpad, etc.) to select the variable they wish to bind to a graphic object (e.g., by clicking, tapping, etc.).

As illustrated in FIG. 11, the method 1100 also includes an act 1108 generating a second graphic object connecting the variable and a cursor position on the digital canvas. Once the variable is selected, a visual indicator (e.g., the second graphic object) is rendered. This second graphic object connects the selected variable and the cursor, providing a visual link between the variable and the cursor. In some embodiments, the second graphic object may trace the path followed by the cursor. Alternatively, the second graphic object may be a curve, line, or other graphic object linking the variable and the current position of the cursor.

As illustrated in FIG. 11, the method 1100 also includes an act 1110 receiving a selection of a visual property of the first graphic object using the cursor, wherein, upon selection of the visual property, the first graphic object is linked to the data panel via the second graphic object. The designer can select a visual property of a graphic object (e.g., directly on the digital canvas or in a panel) to bind the variable to the visual property. The second graphic object provides a visual cue which makes it clear which variable has been linked to which property. Once the binding is created it can be stored.

In some embodiments, available visual properties may be highlighted with targets, making it easier for the designer to identify properties to which to bind the data. For example, in some embodiments, receiving the selection includes highlighting one or more connection points on the first graphic object on the digital canvas and receiving the selection of the visual property via a selection of one of the connection points on the first graphic object. This may be done directly on the digital canvas or on a panel. For example, in some embodiments, receiving the selection includes displaying one or more visual properties of the first graphic object in a properties panel and receiving the selection of the visual property via a selection of one of the properties in the properties panel. In some embodiments, the visual property includes one or more of color, position, area, or size of the first graphic object.

As illustrated in FIG. 11, the method 1100 also includes an act 1112 generating a chart comprising the first graphic object and one or more new graphic objects, based on the variable and the visual property of the first graphic object. As discussed, a new graphic object can be created for each row associated with the variable. This may correspond to different readings of the variable, etc. Using the binding, a new graphic object is created and bound in the same way as the initial graphic object (e.g., to the same visual property). The multiple graphic objects bound to the same dataset form the chart or other data visualization.

As discussed, additional charts may be created by duplicating all or some or a preexisting chart. For example, in some embodiments, the method further includes receiving a selection of the chart and duplicating the chart to create a second chart, wherein the chart and the second chart are both bound to the variable associated with the data set. The underlying data that is bound to the chart can then be swapped with new data. This allows for the look of multiple data visualizations to remain consistent, while representing different data. For example, in some embodiments, the method further includes receiving a selection of a second variable from a second data set, generating a third graphic object connecting the selected second variable and the cursor position, receiving a selection of a second visual property of a second graphic object of the second chart using the cursor, and updating the second chart based on the second variable of the second data set and the second visual property. If the variables do not line up (e.g., different labels, etc.) then the data visualization system may require additional user input to complete the mapping. For example, in some embodiments, updating the second chart includes determining a label associated with the variable of the data set and the second variable of the second data set do not match, receiving an instruction that maps the second variable to the second chart, and modifying the second visual property of the second chart based on the instruction.

In some embodiments, the method may include receiving a selection of a first graphic object on a digital canvas, the first graphic object bound to a first dataset as part of a data visualization. A request to swap datasets associated with the data visualization is received, along with a selection of a variable from a second dataset. Data bindings associated with the data visualization are updated based on the variable from the second dataset and a visual property of each graphic object associated with the data visualization is updated based on the updated data bindings.

In some embodiments, a data visualization is generated by receiving a selection of a variable from the first dataset and binding the variable to the visual property of the first graphic object, wherein the binding is represented visually by an indicator graphic object visually connecting the variable to the visual property. In some embodiments, to aid the designer, properties may be highlighted. In such instances, one or more connection points on the first graphic object are highlighted on the digital canvas and the selection of the visual property is received via a selection of one of the connection points on the first graphic object.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

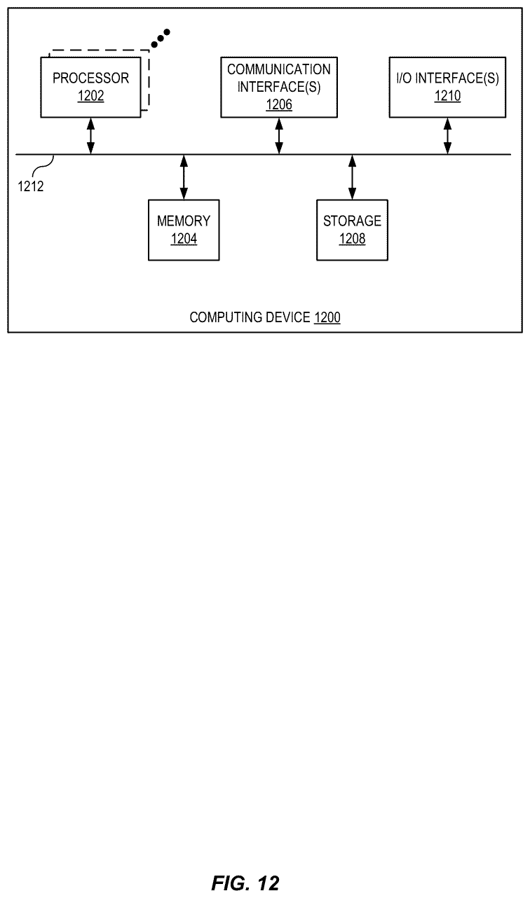

FIG. 12 illustrates, in block diagram form, an exemplary computing device 1200 that may be configured to perform one or more of the processes described above. One will appreciate that one or more computing devices such as the computing device 1200 may implement the data visualization system. As shown by FIG. 12, the computing device can comprise a processor 1202, memory 1204, one or more communication interfaces 1206, a storage device 1208, and one or more I/O devices/interfaces 1210. In certain embodiments, the computing device 1200 can include fewer or more components than those shown in FIG. 12. Components of computing device 1200 shown in FIG. 12 will now be described in additional detail.

In particular embodiments, processor(s) 1202 includes hardware for executing instructions, such as those making up a computer program. As an example, and not by way of limitation, to execute instructions, processor(s) 1202 may retrieve (or fetch) the instructions from an internal register, an internal cache, memory 1204, or a storage device 1208 and decode and execute them. In various embodiments, the processor(s) 1202 may include one or more central processing units (CPUs), graphics processing units (GPUs), field programmable gate arrays (FPGAs), systems on chip (SoC), or other processor(s) or combinations of processors.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1204 may be internal or distributed memory.

The computing device 1200 can further include one or more communication interfaces 1206. A communication interface 1206 can include hardware, software, or both. The communication interface 1206 can provide one or more interfaces for communication (such as, for example, packet-based communication) between the computing device and one or more other computing devices 1200 or one or more networks. As an example and not by way of limitation, communication interface 1206 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can comprise hardware, software, or both that couples components of computing device 1200 to each other.

The computing device 1200 includes a storage device 1208 includes storage for storing data or instructions. As an example, and not by way of limitation, storage device 1208 can comprise a non-transitory storage medium described above. The storage device 1208 may include a hard disk drive (HDD), flash memory, a Universal Serial Bus (USB) drive or a combination these or other storage devices. The computing device 1200 also includes one or more input or output (“I/O”) devices/interfaces 1210, which are provided to allow a user to provide input to (such as user strokes), receive output from, and otherwise transfer data to and from the computing device 1200. These I/O devices/interfaces 1210 may include a mouse, keypad or a keyboard, a touch screen, camera, optical scanner, network interface, modem, other known I/O devices or a combination of such I/O devices/interfaces 1210. The touch screen may be activated with a stylus or a finger.

The I/O devices/interfaces 1210 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1210 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
generating a first graphic object on a digital canvas;
adding a data set including data associated with a plurality of variables to a data panel of the digital canvas;
receiving a selection of a variable from the plurality of variables on the data panel;
generating a second graphic object connecting the variable and a cursor position on the digital canvas;
receiving a selection of a visual property of the first graphic object using the cursor, wherein, upon selection of the visual property, the first graphic object is linked to the data panel via the second graphic object; and
generating a chart comprising the first graphic object and one or more new graphic objects, based on the variable and the visual property of the first graphic object.

2. The method of claim 1, wherein receiving a selection of a visual property of the first graphic object using the cursor, further comprises:
highlighting one or more connection points on the first graphic object on the digital canvas; and
receiving the selection of the visual property via a selection of one of the connection points on the first graphic object.

3. The method of claim 1, wherein receiving a selection of a visual property of the first graphic object using the cursor, further comprises:
displaying one or more visual properties of the first graphic object in a properties panel; and
receiving the selection of the visual property via a selection of one of the properties in the properties panel.

4. The method of claim 1, wherein the visual property includes one or more of color, position, area, or size of the first graphic object.

5. The method of claim 1, further comprising:
receiving a selection of the chart; and
duplicating the chart to create a second chart, wherein the chart and the second chart are both bound to the variable associated with the data set.

6. The method of claim 5, further comprising:
receiving a selection of a second variable from a second data set;
generating a third graphic object connecting the selected second variable and the cursor position;
receiving a selection of a second visual property of a second graphic object of the second chart using the cursor; and
updating the second chart based on the second variable of the second data set and the second visual property.

7. The method of claim 6, wherein updating the second chart based on the second variable and the second visual property, further comprises:
determining a label associated with the variable of the data set and the second variable of the second data set do not match;
receiving an instruction that maps the second variable to the second chart; and
modifying the second visual property of the second chart based on the instruction.

8. A non-transitory computer-readable medium storing executable instructions, which when executed by a processing device, cause the processing device to perform operations comprising:
generating a first graphic object on a digital canvas;
adding a data set including data associated with a plurality of variables to a data panel of the digital canvas;
receiving a selection of a variable from the plurality of variables on the data panel;
generating a second graphic object connecting the variable and a cursor position on the digital canvas;
receiving a selection of a visual property of the first graphic object using the cursor, wherein, upon selection of the visual property, the first graphic object is linked to the data panel via the second graphic object; and
generating a chart comprising the first graphic object and one or more new graphic objects, based on the variable and the visual property of the first graphic object.

9. The non-transitory computer-readable medium of claim 8, wherein receiving a selection of a visual property of the first graphic object using the cursor, further comprises:
highlighting one or more connection points on the first graphic object on the digital canvas; and
receiving the selection of the visual property via a selection of one of the connection points on the first graphic object.

10. The non-transitory computer-readable medium of claim 8, wherein receiving a selection of a visual property of the first graphic object using the cursor, further comprises:
displaying one or more visual properties of the first graphic object in a properties panel; and
receiving the selection of the visual property via a selection of one of the properties in the properties panel.

11. The non-transitory computer-readable medium of claim 8, wherein the visual property includes one or more of color, position, area, or size of the first graphic object.

12. The non-transitory computer-readable medium of claim 8, further comprising:
receiving a selection of the chart; and
duplicating the chart to create a second chart, wherein the chart and the second chart are both bound to the variable associated with the data set.

13. The non-transitory computer-readable medium of claim 12, further comprising:
receiving a selection of a second variable from a second data set;
generating a third graphic object connecting the selected second variable and the cursor position;
receiving a selection of a second visual property of a second graphic object of the second chart using the cursor; and
updating the second chart based on the second variable of the second data set and the second visual property.

14. The non-transitory computer-readable medium of claim 13, wherein updating the second chart based on the second variable and the second visual property, further comprises:
determining a label associated with the variable of the data set and the second variable of the second data set do not match;
receiving an instruction that maps the second variable to the second chart; and
modifying the second visual property of the second chart based on the instruction.

15. A system comprising:
a memory component; and
a processing device coupled to the memory component, the processing device to perform operations comprising:
receiving a selection of a first graphic object on a digital canvas, the first graphic object bound to a first dataset as part of a data visualization;
receiving a request to swap datasets associated with the data visualization;
receiving a selection of a variable from a second dataset;
updating data bindings associated with the data visualization based on the variable from the second dataset; and
updating a visual property of each graphic object associated with the data visualization based on the updated data bindings.

16. The system of claim 15, wherein the data visualization is generated by:
receiving a selection of a variable from the first dataset; and
binding the variable to the visual property of the first graphic object, wherein the binding is represented visually by an indicator graphic object visually connecting the variable to the visual property.

17. The system of claim 16, wherein the operation of binding the variable to the visual property of the first graphic object, wherein the binding is represented visually by an indicator graphic object visually connecting the variable to the visual property further comprises:
highlighting one or more connection points on the first graphic object on the digital canvas; and
receiving the selection of the visual property via a selection of one of the connection points on the first graphic object.

18. The system of claim 16, wherein the operation of binding the variable to the visual property of the first graphic object, wherein the binding is represented visually by an indicator graphic object visually connecting the variable to the visual property further comprises:
displaying one or more visual properties of the first graphic object in a properties panel; and
receiving the selection of the visual property via a selection of one of the properties in the properties panel.

19. The system of claim 15, wherein the operation of updating data bindings associated with the data visualization based on the variable from the second dataset, further comprises:
receiving a mapping of the variable from the second dataset to a bound variable from the first dataset; and
updating the data bindings based on the mapping.

20. The system of claim 15, wherein the visual property includes one or more of color, position, area, or size of the first graphic object.
